(19) United States
(12) Patent Application Publication
(10) Pub. No.: US 2026/0319678 A1
(43) Pub. Date: Oct. 15, 2026

(54) METHOD FOR THE COMPUTER-AIDED RESTRICTION OF PERSISTENT MEMORY FOR A CONTAINER-BASED APPLICATION

(71) Applicant: Siemens Aktiengesellschaft, München (DE)

(72) Inventors: Christian Knierim, München (DE); Harald Albrecht, Nürnberg (DE); Christian Peter Feist, Grafrath (DE)

(21) Appl. No.: 19/106,528

(22) PCT Filed: Aug. 9, 2023
(86) PCT No.: PCT/EP2023/072085

§ 371 Date: Feb. 25, 2025

(30) Foreign Application Priority Data
Aug. 29, 2022 (EP) 22192677.7

(51) Int. Cl. G06F 3/06

(52) U.S. Cl. CPC G06F 3/0629; G06F 3/062; G06F 3/0673

(57) ABSTRACT

A method for the computer-supported restricting of persistent memory for a container-based application includes: providing a piece of configuration information to configure a number of container instances assigned to the application, the piece of configuration information defining, for each first user contained in the container instances, a storage limit of persistent memory on at least one memory partition of a specified operating system; defining a user assignment during configuration of the number of container instances, according to which another second user is assigned to each first user in the specified operating system, which second user is unique across the number of container instances and for which the storage limit of the respective first user is valid; and starting the number of container instances based on the user assignment, wherein with the aid of the second user or users the storage limit for each first user is adhered to.

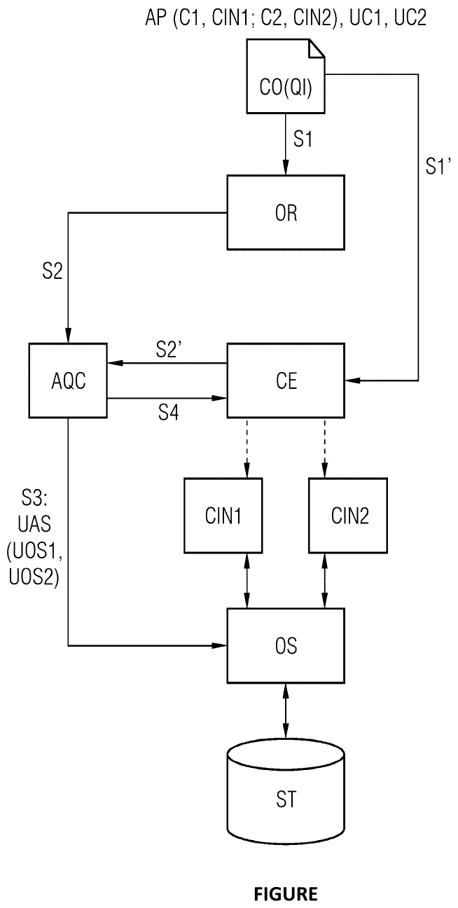

The present patent document is a § 371 nationalization of PCT Application Serial No. PCT/EP 2023/072085, filed Aug. 9, 2023, designating the United States, and this patent document also claims the benefit of European Patent Application No. 22192677.7, filed Aug. 29, 2022, which are incorporated by reference in their entireties.

### TECHNICAL FIELD

The disclosure relates to a method for the computer-aided restriction of persistent memory for a container-based application and to a corresponding computer program product and a corresponding computer program.

### BACKGROUND

It is known from the prior art to store executable programs in the form of applications in one or more containers, thus achieving suitable encapsulation of the application. For this purpose, there are containerization technologies, for example the “Docker” software for the Linux operating system.

In order to execute a container-based application from one or more containers, corresponding container instances are configured for the respective containers and are started when executing the application.

There may be the need to make the data generated by a container-based application persistent, e.g., store them in a non-volatile memory, such that the data are available for specific devices (for example sensors) or other applications.

In order to make data within a container instance persistent at the runtime of an application, a persistent memory partition of the underlying operating system may be incorporated or mounted in the container, such that the associated container-based application may carry out change operations in the persistent memory partition. The persistent memory partition may be shared by different container instances. Using source directories within the memory partition, to which only ever one individual container instance has access, makes it possible to control the fact that the container instances do not write to the same directory. Nevertheless, there is the problem of one or more container instances still being able to allocate the complete memory partition and no persistent memory space then being available for other container instances and therefore no longer being able to make any data persistent.

Currently, there are no adequate solutions for restricting the persistent memory for container instances of an application. Although it is possible to define separate memory partitions for individual container instances, it is disadvantageous in this case that the number of memory partitions that may be generated is limited and the processes for generating the memory partitions are very complicated.

U.S. Patent Application Publication No. 2022/083383 A1 discloses configuring resource limits of the resource allocation for containers, including the allocation of the memory SGX EPC, in the Linux operating system with the aid of Linux Security Modules LSM and Extended Berkely Program Format (eBPF) programs.

In addition, it is possible in the prior art to control the memory requirement in a memory partition using so-called disk quotas which define memory restrictions for users or user groups on a file system of an operating system. However, disk quotas are not provided for the purpose of restricting persistent memory for container instances.

### SUMMARY AND DESCRIPTION

The object of the disclosure is to provide a method that may be used to easily restrict persistent memory for a container-based application.

This object is achieved by a method, a computer program product, and a computer program as described herein. The scope of the present disclosure is defined solely by the appended claims and is not affected to any degree by the statements within this summary. The present embodiments may obviate one or more of the drawbacks or limitations in the related art.

The method is used for the computer-aided restriction of persistent memory for a container-based application. Container-based applications are known per se from the prior art. A container-based application is assigned a number of container instances (e.g., one or more container instances), which are configured within the method and are then started in order to execute the application on a predefined operating system. If Linux is used as the predefined operating system, for example, the container instances may be generated using the “Docker” containerization technology that is known per se.

The number of container instances include a number of first users (e.g., one or more first users) each used to execute at least one process in the number of container instances after they have been started. A respective first user is a container-specific user in a corresponding container instance from the number of container instances. Defining container-specific users with corresponding user identities, who are responsible for executing one or more processes in a container instance, is known per se from the prior art. The first user is a (non-human) technical user provided with an appropriate authorization to execute one or more processes of the corresponding container instance.

In the method, in order to configure the number of container instances, configuration information is or has been provided and defines, for each first user, a memory restriction of persistent memory in at least one memory partition of the predefined operating system. The term “memory restriction” should be broadly understood here. The memory restriction may be given, for example, by directly stating a maximum memory size. The memory restriction may likewise be defined indirectly, for example by stating that only a specific number of files and/or only files up to a specific size may be written to the corresponding persistent memory. A memory restriction may be defined for a respective first user, possibly also via a user group. In this case, the memory is restricted for all first users belonging to the same user group.

In the method, when configuring the number of container instances, a user assignment is defined, according to which each first user is assigned another, second user who is unique across the number of container instances and for whom the memory restriction of the respective first user is valid. A respective second user is a user with a corresponding user identity in the predefined operating system who was not used or allocated in this operating system before being assigned to the first user. Such second users may be defined at the operating system level, for example using the above-described mechanism of disk quotas.

The number of container instances are finally started on the basis of the user assignment described above. In this case, the memory restriction for each first user is complied with for the number of started container instances by the second user(s). In other words, when starting the corresponding container instances, the user assignment is taken into account when mounting the file systems of the container instances in the file system of the predefined operating system, with the result that the memory restriction for a respective second user is used when a process is being executed by the associated first user. Consequently, a first user is not allowed to write to the corresponding memory partition if the memory restriction for this user has been exceeded.

The method has the advantage that the persistent memory may be easily restricted for a container-based application by uniquely assigning container-specific users to operating system users. The memory restrictions may be flexibly changed by appropriate adaptations in the configuration information.

In one variant of the method, in the configuration information, at least some of the first users of the number of first users are assigned to one or more user groups, wherein each user group is assigned the same memory restriction for all first users contained therein. In other words, each first user of at least some of the first users belongs to a corresponding user group, in which case there may be one or more user groups. This embodiment may be used to easily structure the configuration information, since first users with the same memory restriction are combined to form a group and the memory restriction therefore no longer needs to be separately stated for these users.

In a further embodiment of the method, in the configuration information, the memory restriction for a respective first user of the number of first users is defined for one or more directories of a container-specific file system. In other words, the memory restriction relates to one or more directories within the corresponding container that may be accessed by the respective first user. The configuration information also specifies the at least one memory partition of the predefined operating system that corresponds to the directory or directories of the container-specific file system. In an alternative variant, it is also possible for the memory restriction for a respective user to directly indicate the at least one memory partition of the predefined operating system in the configuration information.

The method can be used for different operating systems. However, Linux is used as the predefined operating system in one variant. When Linux is used, the user assignment described above may be defined on the basis of the mechanism of user namespaces that is known from this operating system. The use of user namespaces is known per se. These user namespaces are discussed in more detail in the detailed description.

In a further configuration, the configuration information is provided standard configuration information if no other configuration information is provided for the container-based application. This provides that an application is started with standard values of memory restrictions, even if there is no application-specific configuration information.

In a further configuration of the method, when defining the user assignment, a check is carried out in order to determine whether the memory restriction is permissible for a respective first user of the number of first users, wherein the permissibility may be defined on the basis of any permissibility criteria. If there are one or more impermissible memory restrictions, these impermissible memory restrictions are rejected in one variant, that is to say the method is continued without taking the impermissible memory restrictions into account. Alternatively, the impermissible memory restrictions may also be replaced with permissible memory restrictions. In a further alternative, it is also possible for the method to be aborted on account of the impermissible memory restrictions.

If the configuration information contains memory restrictions based on directories of a container-specific file system, as described above, there are impermissible memory restrictions, for example, when different memory limits are specified for two container-specific directories, even though the directories are in the same memory partition.

In a further embodiment, the user assignment, which is defined when configuring the number of container instances, is stored beyond the completion of the method. This means that, when the method is carried out again, it is possible to access the defined user assignment, without this having to be determined or defined again.

Nevertheless, it is also possible for the user assignment to be newly implemented each time the method is carried out again. This provides that interim changes in the operating system are suitably taken into account.

In a further configuration, the container-based application is executed in a data network, wherein the data network may be provided for the purpose of controlling an automation system. The disclosure may therefore be used in the industrial environment.

In one variant, the data network in which the container-based application is executed is a so-called edge computing network having a multiplicity of edge nodes or edge devices, wherein the container-based application is executed on an edge device of the multiplicity of edge devices and the at least one memory partition is provided on the edge device. Edge computing networks are known per se from the prior art. Such networks may be used in industrial applications. Nevertheless, the disclosure is not restricted to edge computing networks and may also be used in other data networks, for example, cloud-based networks.

In addition to the method described above, the disclosure relates to a computer program product having program code stored on a machine-readable carrier for carrying out the method or one or more variants of the method when the program code is executed on a computer.

In addition, the disclosure relates to a computer program having program code for carrying out the method or one or more variants of the method when the program code is executed on a computer.

### BRIEF DESCRIPTION OF THE DRAWINGS

An embodiment of the disclosure is described in detail below using the accompanying FIGURE.

The FIGURE depicts a schematic illustration representing an example of a sequence of the method.

### DETAILED DESCRIPTION

An embodiment of the disclosure explained below using the FIGURE relates to the restriction of persistent memory for a container-based application AP containing, for example, the software containers C1 and C2. The application AP is executed on the operating system OS using a container runtime environment that is known per se. For this purpose, a container instance CIN1 of the container C1 and a container instance CIN2 of the container C2 are started using the container runtime environment CE. Without restricting generality, it is assumed below that the operating system OS is Linux.

The container-based application may be based on a containerization technology that is known per se. The “Docker” software may be used as the containerization technology. The container-based application AP may be an application in a cloud computing network. Alternatively, the application may run in an edge computing network in which, in contrast to a cloud computing network, operations are carried out locally at the edge of the network in so-called edge nodes or edge devices, in which case the application AP runs on one of the edge devices.

In a manner known per se, the container instance CIN1 is assigned a user UC1 and the container instance CIN2 is assigned a user UC2, in which case the users are technical (non-human) users for whom a corresponding authorization to execute the associated container instances CIN1 and CIN2 is stored. The users UC1 and UC2, who are first users as defined in certain examples herein, are container-specific users defined locally or in an encapsulated manner for the container instances CIN1 and CIN2. That is to say, the user UC1 is a container-specific user for the container C1 or the corresponding container instance CIN1 and the user UC2 is a container-specific user for the container C2 or the corresponding container instance CIN2. If necessary, a respective container instance may also contain a plurality of users each separately assigned one or more processes that are executed by the respective container instance.

Before executing the application AP or starting the corresponding container instances CIN1 and CIN2, the container instances are configured on the basis of the underlying containers. For configuration, use is made of configuration information CO in the form of a corresponding configuration file which, in addition to configuration settings known per se, also contains restriction information QI that defines, for the respective container-specific users UC1 and UC2, a corresponding restriction of their usable persistent memory space in a memory partition of a physical memory ST in the underlying operating system OS.

In the embodiment in the FIGURE, use is made of an orchestrator OR (for example, Kubernetes) which is known per se, manages a plurality of container runtime environments and selects, according to specific criteria, the runtime environment which executes the application AP. This is the illustrated runtime environment Container Engine (CE) in the FIGURE.

According to act S1 indicated as an arrow in the FIGURE, the configuration information CO is transferred, together with the restriction information QI, to the orchestrator OR that transfers the restriction information QI, together with a unique identifier for the container instances CIN1 and CIN2 to be configured, to a configuration component AQC, as illustrated by act S2 indicated as an arrow. The unique identifier for the respective container instance may be composed of the name of the application and of the container. If the Kubernetes orchestrator which is known per se is used, for example, the unique identifier may be formed from a combination of namespace, pod name and container name.

In an alternative embodiment, the orchestrator OR may also be omitted, the container runtime environment CE being firmly predefined in this case for executing the application AP. Without the orchestrator, the configuration information CO, together with the restriction information QI, is transferred directly to the container runtime environment CE (act S1′) which then transfers the restriction information QI, together with a unique identifier of the container instances CIN1 and CIN2 to be configured, to the component AQC (act S2′).

As mentioned above, the restriction information QI contains a memory restriction for each of the available container-specific users UC1 and UC2. In the embodiment described here, the memory restrictions are defined on the basis of maximum memory sizes for container-specific directories of the respective users, wherein the container-specific directories are each linked to the persistent memory of a corresponding memory partition in the memory ST. For the user UC1, there are therefore one or more directories which are specific to the container instance CIN1 and are assigned to a memory partition of the operating system OS. In the same manner, for the container-specific user UC2, there are one or more directories which are specific to the container instance CIN2 and are assigned to a memory partition of the operating system OS. In other words, the restriction information QI defines from which source directories of the memory partition which target containers with corresponding users are intended to receive persistent directories mounted in which container directories. As mentioned, in the embodiment described here, the memory restrictions for the container-specific users indicate a maximum memory size, but the memory restriction may also be defined in another way, for example on the basis of a maximum number of files that may be written to the corresponding memory partition.

In the text above, the memory restriction of the users of the individual container instances was defined on the basis of container directories each assigned a restricted persistent memory in a memory partition of the operating system OS. If appropriate, the memory restriction may also be defined such that the memory partition of the operating system that is intended to be restricted is directly indicated for the respective container instances.

In the embodiment described here, after receiving the restriction information QI, the component AQC first of all carries out a check in order to determine whether the corresponding memory restrictions in the restriction information QI are actually permissible according to certain permissibility criteria. A permissibility criterion is that all container-specific directories are of the same size in the memory restrictions of the container-specific users, if the directories belong to the same memory partition that is restricted in the memory. Therefore, those memory restrictions for whose container-specific directories different memory sizes are indicated are not permissible if the directories are mounted in the same memory partition of the operating system OS.

If certain memory restrictions are considered to be impermissible, these impermissible memory restrictions are not implemented in the embodiment described here. Alternatively, it is also possible for the impermissible memory restrictions to be adapted in such a manner that they become permissible again. For example, if the corresponding container-specific directories, which are assigned to the same memory partition of the operating system, have different maximum memory values for two memory restrictions, all directories may be set to the same memory value, for example, the largest memory value of all directories, as a result of which the corresponding memory restrictions become permissible again. In a further variant, it is also possible for the method to be aborted in the event of impermissible memory restrictions. That is to say, no container instances are started and the application is not executed.

After carrying out the permissibility check described above, the component AQC now sets up the memory restrictions according to the restriction information QI using the operating system OS. In this case, a common user namespace is set up for the container instances CIN1 and CIN2 whose users OC1 and OC2 are intended to be subject to a corresponding memory restriction. User namespaces are a mechanism that is known per se from the Linux operating system. A user namespace describes a unique mapping of container-specific users to corresponding users with user identities in the Linux operating system. The mapping is selected in such a manner that the user identities in the Linux operating system OS are not allocated otherwise for processes of the operating system. The generation of the user namespace is indicated in act S3 in the FIGURE. According to this act, a user assignment UAS is defined in the form of a user namespace in which the container-specific user UC1 is assigned to the operating system user UOS1 and the container-specific user UC2 is assigned to the operating system user UOS2.

The user namespace is used to shift the container-specific users of a container instance by an offset. Therefore, write operations with the container-specific user identity 0 are carried out, for example, within a user namespace on the underlying operating system with the user identity of the offset. The offset is suitably specified by the component AQC when creating the user namespace, in which case the component AQC uses, for this purpose, the restriction information QI transferred by the orchestrator OR in act S2 or by the runtime environment CE in act S2′. The interaction between the runtime environment or the orchestrator and the component AQC may be carried out, for example, with the aid of plug-ins. The above offset is determined by virtue of the component AQC evaluating the container-specific user identities and using them to calculate how great the distance is to the next user namespace. In a modified embodiment, user groups may possibly also be defined for the individual container-specific users, that is to say a respective user is assigned to a user group. A corresponding memory restriction is consistently defined for a user group and is then valid for all container-specific users in the user group, thus simplifying the method.

In act S4, the user namespace or the user assignment UAS, determined in act S3 by the component AQC, is transferred to the runtime environment CI which then implements the corresponding memory restrictions according to the restriction information QI using the user namespace. In this case, the memory restrictions are not allocated on the basis of the container-specific users UC1, UC2 within the user namespace and therefore in the container, but rather on the basis of the actual users or user identities UOS1, UOS2 of the underlying operating system OS. For example, in the case of an offset in the user namespace of 2000 for the container-specific user with the user identity 0, a memory restriction is allocated to the user identity 2000 of the operating system OS and not to the user identity 0.

When implementing the user namespace, the container-specific file systems are mounted or incorporated using the user namespace. The container instances CIN1 and CIN2 are then started, as indicated by two dashed arrows in the FIGURE. The user namespace is used to implement the corresponding memory restrictions in the operating system OS. In other words, write operations of the corresponding container instances CIN1 and CIN2, which are indicated by double-headed arrows between the instances and the operating system OS in the FIGURE, are restricted according to the memory restrictions in the restriction information, that is to say it is provided that the persistent memory in the corresponding memory partition of the physical memory ST is not written to by the container-specific users, in turn assigned to operating system users, beyond the memory restriction. Write operations with which a memory restriction is exceeded are therefore not permitted for the respective user in the container instance.

In one variant of the method, the user assignment or the user namespace UAS is stored, with the result that it is available again if the application AP or the corresponding container instances CIN1 and CIN2 is/are restarted. Alternatively, it is also possible for the user assignment or the user namespace UAS to be newly calculated each time the application AP is restarted, with the result that the assignment is dynamically adapted and changes in the operating system OS may therefore be suitably taken into account if appropriate. Both when reusing the user namespace and when recalculating it, it is provided that the offset shift with the user namespace is reversed again when stopping the corresponding application, such that the user namespace is correctly defined again on restart.

The embodiments of the disclosure described above have a number of advantages. In particular, it is possible to suitably restrict the amount of available persistent memory for container-specific users of container instances. This prevents a container instance, which is started, for example, by an attacker as part of a DOS attack (DoS=Denial of Service), from completely writing to a physical memory such that other container instances which access the same physical memory are prevented from being executed. In one variant, use is made of a mechanism that is known per se for implementing the corresponding memory restrictions in the form of a user namespace of the Linux operating system. The user namespace may be dynamically allocated, if appropriate, each time the application or the corresponding container instances is/are restarted. If appropriate, a determined user namespace may also be stored in order to be reused if the application or the associated container instances is/are restarted.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for a computer-aided restriction of persistent memory for a container-based application, wherein the container-based application is assigned one or more container instances that are configured and then started in order to execute the container-based application on a predefined Linux operating system, wherein the one or more container instances comprise a number of container instances of first users that are each used to execute at least one process in the one or more container instances after the one or more container instances have been started, wherein a first user is a container-specific user in a corresponding container instance, wherein the method comprises:
providing configuration information in order to configure the one or more container instances, wherein the configuration information, defines, for each first user, a memory restriction of persistent memory in at least one memory partition of the predefined Linux operating system;
defining a user assignment when configuring the one or more container instances, according to which each first user is assigned a second operating system user who is unique across the one or more container instances and for whom the memory restriction of the respective first user is valid, wherein the second operating system user is a user in the predefined Linux operating system who was not used in the predefined Linux operating system before being assigned to the first user, wherein the user assignment is defined based on a Linux user namespace, and wherein a common user namespace is set up for the one or more container instances whose users are intended to be subject to a corresponding memory restriction; and
starting one or more container instances based on the user assignment, wherein the memory restriction for each first user is complied with aid of second operating system users in the Linux user namespace.

2. The method of claim 1, wherein at least a portion of the first users are assigned to one or more user groups, and
wherein each user group of the one or more user groups is assigned a same memory restriction for all first users contained within the respective user group.

3. The method of claim 2, wherein the memory restriction for a respective first user of the first users is defined for one or more directories of a container-specific file system, and
wherein the configuration information also specifies the at least one memory partition of the predefined Linux operating system that corresponds to a directory or directories of the container-specific file system.

4. The method of claim 3, wherein the configuration information is provided standard configuration information when no other configuration information is provided for the container-based application.

5. The method of claim 4, wherein the defining of the user assignment comprises carrying out a check in order to determine whether the memory restriction is permissible for a respective first user of the first users, and
wherein, when there are one or more impermissible memory restrictions, the one or more impermissible memory restrictions are rejected or replaced with permissible memory restrictions or the method is aborted.

6. The method of claim 5, further comprising:
storing the user assignment, which is defined when configuring the one or more container instances.

7. A computer program product having program code stored on a machine-readable carrier, wherein the program code, when is executed on a computer, causes the computer to:
provide configuration information in order to configure one or more container instances for executing a container-based application on a predefined Linux operating system, wherein the one or more container instances comprise a number of container instances of first users that are each used to execute at least one process in the one or more container instances after the one or more container instances have been started, wherein a first user is a container-specific user in a corresponding container instance, and wherein the configuration information defines, for each first user, a memory restriction of persistent memory in at least one memory partition of a predefined operating system;
define a user assignment when configuring the one or more container instances, according to which each first user is assigned a second operating system user who is unique across the one or more container instances and for whom the memory restriction of the respective first user is valid, wherein the second operating system user is a user in the predefined operating system who was not used in the predefined operating system before being assigned to the first user, wherein the user assignment is defined based on a Linux user namespace, and wherein a common user namespace is set up for the one or more container instances whose users are intended to be subject to a corresponding memory restriction; and
start the one or more container instances based on the user assignment, wherein the memory restriction for each first user is complied with aid of second operating system users in the Linux user namespace.

8. (canceled)

9. The method of claim 1, wherein the memory restriction for a respective first user of the first users is defined for one or more directories of a container-specific file system, and
wherein the configuration information also specifies the at least one memory partition of the predefined Linux operating system that corresponds to a directory or directories of the container-specific file system.

10. The method of claim 1, wherein the configuration information is provided standard configuration information when no other configuration information is provided for the container-based application.

11. The method of claim 1, wherein the defining of the user assignment comprises carrying out a check in order to determine whether the memory restriction is permissible for a respective first user of the first users, and
wherein, when there are one or more impermissible memory restrictions, the one or more impermissible memory restrictions are rejected or replaced with permissible memory restrictions or the method is aborted.

12. The method of claim 1, further comprising:
storing the user assignment, which is defined when configuring the one or more container instances.
